(19) United States
(12) Patent Application Publication
(10) Pub. No.: US 2024/0172754 A1
(43) Pub. Date: May 30, 2024

(54) PESTICIDAL COMPOSITIONS

(71) Applicant: SYNGENTA CROP PROTECTION AG, Basel (CH)

(72) Inventors: Daniel SCHNEIDER, Münchwilen (CH); Christian POPP, Münchwilen (CH)

(73) Assignee: SYNGENTA CROP PROTECTION AG, Basel (CH)

(21) Appl. No.: 18/551,219

(22) PCT Filed: Mar. 17, 2022
(86) PCT No.: PCT/EP2022/056920

§ 371 Date: Sep. 19, 2023

(30) Foreign Application Priority Data
Mar. 19, 2021 (EP) 21163726.9

(51) Int. Cl. A01N 47/06; A01N 25/04; A01P 7/02; A01P 7/04

(52) U.S. Cl. CPC A01N 47/06; A01N 25/04; A01P 7/02; A01P 7/04

(57) ABSTRACT

A pesticidal composition comprising: (a) 20 to 35% by weight of spiropidion as active ingredient, and (b) 5.5 to 15% by weight of a dispersing agent combination, comprising: (i) 5 to 10% by weight of the total composition of an acrylic graft copolymer solution in water and propylene glycol; and (ii) 0.5 to 5% by weight of the total composition of a sodium alkyl naphthalene sulfonate formaldehyde condensate.

The present invention relates to a pesticidal composition, in particular a suspension concentrate composition, comprising an insecticidal active ingredient, to the preparation thereof and to a method of using such a composition to control pests in crops of useful plants.

WO 2010/066780, WO 2018/114648 and WO 2018/114649 disclose that certain spiroheterocyclic pyrrolidine dione derivative compounds (including spiropodion) have pesticidal activity, in particular, insecticidal and acaricidal activity. The activity of such compounds applied to plants in a pesticide spray formulation may be enhanced with the use of a pesticide adjuvant, which is a substance which when present in a pesticide spray formulation improves pesticidal active ingredient performance, for example by facilitating the spreading of the active ingredient on a leaf surface or penetration into the leaf and so the plant's vasculature. Under certain circumstances, the adjuvant substance is not a component of the active ingredient concentrate, rather is added to a spray tank along with an active ingredient concentrate prior to application on the plant.

Accordingly, there remains a strong motivation to develop stable and effective insecticidal compositions comprising spiropidion which are suitable for use with adjuvants in order to enhance product penetration, whilst also possessing a favourable crop safety profile, eg, for the use on fruit and vegetable plants.

According to the present invention, there is provided a pesticidal composition comprising:
(a) 20 to 35% by weight of spiropidion as active ingredient, and
(b) 5.5 to 15% by weight of a dispersing agent combination, comprising:
   (i) 5 to 10% by weight of the total composition of an acrylic graft copolymer solution in water and propylene glycol; and
   (ii) 0.5 to 5% by weight of the total composition of a sodium alkyl naphthalene sulfonate formaldehyde condensate.

The pesticidal compositions of the present invention have, for practical purposes, a very advantageous level of activity in controlling insect pests in crops of useful plants after foliar or soil application, whilst also maintaining acceptable crop safety (phytotoxicity) outcomes. By activity, it is meant that the compositions of the invention are capable of killing or controlling insects, retarding the growth or reproduction of insects, reducing an insect population, and/or reducing damage to plants caused by insects. The pesticidal compositions of the present invention also possess strong storage stability for both the overall composition and the active ingredient component, particularly at elevated temperature.

Further according to the invention, there is provided an aqueous composition comprising the pesticidal composition according the invention, optionally further comprising one or more adjuvants or carriers. The adjuvant may be selected from a mineral oil, a vegetable oil, an esterified vegetable oil, a methylated vegetable oil or an alkyl ester phosphate-based adjuvant.

Still further according to the invention, there is provided a (non-therapeutic) method of combating and controlling pests which comprises applying to a pest, to a locus of a pest (eg, soil), or to a crop of a useful plant susceptible to attack by a pest a composition according to the invention.

Spiropidion ([3-(4-chloro-2,6-dimethyl-phenyl)-8-methoxy-1-methyl-2-oxo-1,8-diazaspiro[4.5]dec-3-en-4-yl]ethyl carbonate. CAS no.: 1229023-00-0) is known inter alia from WO 2010/066780, WO 2018/114648 and WO 2018/114649.

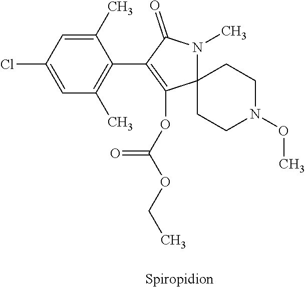 [SMILES: CCOC(=O)OC1=C(c2c(C)cc(Cl)cc2C)C(=O)N(C)C12CCN(OC)CC2 ; "Spiropidion"]

Preferably, the composition according to the present invention comprises as the pesticidal active ingredient component 25 to 30% by weight of spiropidion, and preferably 26 to 29% by weight of spiropidion.

Preferably, the composition according to the present invention is a suspension concentrate (SC), which is a stable suspension of a solid pesticidal active ingredient compound in a liquid, usually intended for dilution with water (in a spray tank or other vessel) before use.

A dispersant or a dispersing agent is typically a surfactant substance, which when added to a suspension of solid particles in a liquid better enables the separation of the particles to avoid their settling or clumping together. The dispersant system of the compositions according to the invention comprises two components (i) and (ii).

Dispersants (non-ionic) which may be used in component (i) of the dispersing agent combination in accordance with the present invention may comprise a graft copolymer which is a 2-methyl-2-propenoic acid and methyl 2-methyl-2-propenoate polymer with α-methyl-Ω-hydroxypoly(oxy-1,2-ethanediyl) graft. In certain embodiments, this may be otherwise defined as a methyl methacrylate/methacrylic acid/monomethoxypolyethylene glycol (PEG) methacrylate graft copolymer (eg, Atlox™ 4913, Uniqema Surfactants Ltd, UK). Such surfactant component may have a minimum number average molecular weight of 2,500 to 3000 Da, and preferably 2,650 to 2,800 Da. Preferably, component (i) is present at 6 to 9% by weight of the total composition, and more preferably 7 to 8% by weight of the total composition.

Component (ii) of the dispersing agent combination is a sodium alkyl naphthalene sulfonate formaldehyde condensate (eg, Morwet D-425, Nouryon Surface Chemistry AB, Sweden. CAS no.: 9084-06-4 ((C₁₀H₈O₃S·CH₂O)ₙ·xNa)). Preferably, component (ii) is present at 1 to 3% by weight of the total composition.

Preferably, the compositions according to the invention comprise 3 to 8% by weight of an anti-freeze agent (more preferably, 4 to 6% by weight), which may be selected from ethylene glycol or propylene glycol.

Preferably, the compositions according to the invention comprise 0.1 to 2% by weight of a thickening agent, which may be selected from a natural gum substance, such as guar gum or xanthan gum.

Preferably, the compositions according to the invention comprise 0.1 to 2% by weight of a buffering agent. Preferably, the buffering agent is an organic acid that contains 1, 2 or 3 carboxylic acid groups. More preferably, the organic acid is a tricarboxylic acid (ie, contains three carboxylic acid groups) such as citric acid, or a sodium or potassium salt thereof.

Preferably, the compositions according to the invention comprise an amount (less than 0.5% by weight) of a preservative or anti-microbial agent.

The compositions of the invention may additionally comprise water up to 100% by weight of the composition.

Preferably, in an aqueous composition according to the invention (eg, a tank mix preparation for applying to a crop), the adjuvant is selected from a mineral oil, a vegetable oil, an esterified vegetable oil, a methylated vegetable oil or an alkyl ester phosphate-based adjuvant. A pesticide adjuvant may be defined as a substance present in a pesticidal composition (eg, a concentrated active ingredient formulation diluted in water in a tank for a foliar spray application on a crop), which improves pesticidal active ingredient performance, for example by facilitating the spreading of the active ingredient on a leaf surface or penetration into the leaf of the crop plant.

Examples of adjuvant classes, which may be used in accordance with the present invention include a mineral oil, a vegetable oil, an esterified vegetable oil, a methylated vegetable oil or an alkyl ester phosphate-based adjuvant. Commercially-available adjuvant products which may be tank-mixed to yield a spray formulation with the composition of the present invention include HASTEN™ (Victorian Chemical Co. Pty. Ltd.—blend of an esterified vegetable oil and non-ionic surfactants), OCHIMA® (Syngenta—alkyl ester of phosphoric acid (EC formulation)), LEDNA™ (Polaquimia—EC formulation comprising a methyl ester of soybean oil), Atplus® 463 (CRODA Europe Limited—60% paraffin oil with surfactant blend), Actirob® B (Bayer AG—rapeseed oil methyl ester (esterified vegetable oil)), Destiny® HC (Winfield Solutions LLC—methylated soybean oil), DYNE-AMIC® (HELENA—blend of (methylated) vegetable oil and organosilicone-based nonionic surfactants), and FS Optique™ (GROWMARK, Inc—methyl ester of canola oil). If an alkyl ester phosphate-based adjuvant is used in conjunction with the pesticidal composition according to the invention (ie, in a tank mix), the alkyl ester phosphate of the adjuvant is preferably tris-(2-ethylhexyl) phosphate, preferably in combination with ethoxylated sorbitol, hexaoleate, eg, OCHIMA®—EC, Syngenta.

An anti-foaming agent is a chemical additive that reduces and hinders the formation of foam in a composition, such as a pesticidal formulation. Anti-foaming agents which may be used in accordance with the present invention include, but are not limited to, polydimethylsiloxanes (eg, XIAMETER™ ACP-1500, Dow, Inc; Antifoam MSA, Univar; Xiameter ACP-0001, Dow Brasil; Xiameter ACP-0100, Dow Chemical; SAG™ 1572, Momentive Performance Materials Inc.).

A filler may be used in accordance with the present invention.

Examples of pests which may be controlled in accordance with the compositions of the present invention include those:
from the order Acarina, for example, Acalitus spp, Aculus spp, Acaricalus spp, Aceria spp, Acarus siro, Amblyomma spp., Argas spp., Boophilus spp., Brevipalpus spp., Bryobia spp, Calipitrimerus spp., Chorioptes spp., Dermanyssus gaffinae, Dermatophagoides spp, Eotetranychus spp, Eriophyes spp., Hemitarsonemus spp, Hyalomma spp., Ixodes spp., Olygonychus spp, Ornithodoros spp., Polyphagotarsone latus, Panonychus spp., Phyllocoptruta oleivora, Phytonemus spp, Polyphagotarsonemus spp, Psoroptes spp., Rhipicephalus spp., Rhizoglyphus spp., Sarcoptes spp., Steneotarsonemus spp, Tarsonemus spp. and Tetranychus spp.;
from the order Anoplura, for example, Haematopinus spp., Linognathus spp., Pediculus spp., Pemphigus spp. and Phylloxera spp.;
from the order Coleoptera, for example, Agriotes spp., Amphimallon majale, Anomala orientalis, Anthonomus spp., Aphodius spp, Astylus atromaculatus, Ataenius spp, Atomaria linearis, Chaetocnema tibialis, Cerotoma spp, Conoderus spp, Cosmopolites spp., Cotinis nitida, Curculio spp., Cyclocephala spp, Dermestes spp., Diabrotica spp., Diloboderus abderus, Epilachna spp., Eremnus spp., Heteronychus arator, Hypothenemus hampei, Lagria vilosa, Leptinotarsa decemLineata, Lissorhoptrus spp., Liogenys spp, Maecolaspis spp, Maladera castanea, Megascelis spp, Melighetes aeneus, Melolontha spp., Myochrous armatus, Orycaephilus spp., Otiorhynchus spp., Phyllophaga spp, Phlyctinus spp., Popiffia spp., Psyffiodes spp., Rhyssomatus aubtilis, Rhizopertha spp., Scarabeidae, Sitophilus spp., Sitotroga spp., Somaticus spp, Sphenophorus spp, Sternechus subsignatus, Tenebrio spp., Tribolium spp. and Trogoderma spp.;
from the order Diptera, for example, Aedes spp., Anopheles spp, Antherigona soccata, Bactrocea oleae, Bibio hortulanus, Bradysia spp, Calliphora erythrocephala, Ceratitis spp., Chrysomyia spp., Culex spp., Cuterebra spp., Dacus spp., Delia spp, Drosophila melanogaster, Fannia spp., Gastrophilus spp., Geomyza tripunctata, Glossina spp., Hypoderma spp., Hyppobosca spp., Liriomyza spp., Lucilia spp., Melanagromyza spp., Musca spp., Oestrus spp., Orseolia spp., Oscinella frit, Pegomyia hyoscyami, Phorbia spp., Rhagoletis spp, Rivelia quadrifasciata, Scatella spp, Sciara spp., Stomoxys spp., Tabanus spp., Tannia spp. and Tipula spp.;
from the order Hemiptera, for example, Acanthocoris scabrator, Acrosternurn spp, Adelphocoris lineolatus, Amblypelta nitida, Bathycoelia thalassina, Blissus spp, Cimex spp., Clavigralla tomentosicoffis, Creontiades spp, Distantiella theobroma, Dichelops furcatus, Dysdercus spp., Edessa spp, Euchistus spp., Eurydema pulchrum, Eurygaster spp., Halyomorpha halys, Horcias nobilellus, Leptocorisa spp., Lygus spp, Margarodes spp, Murgantia histrionic, Neomegalotomus spp, Nesidiocoris tenuis, Nezara spp., Nysius simulans, Oebalus insularis, Piesma spp., Piezodorus spp, Rhodnius spp., Sahlbergella singularis, Scaptocoris castanea, Scotinophara spp., Thyanta spp., Triatoma spp., and Vatiga illudens;
from the order Homoptera, for example, Acyrthosium pisum, Adalges spp, Agalliana ensigera, Agonoscena targionii, Aleurodicus spp, Aleurocanthus spp, Aleurolobus barodensis, Aleurothrixus floccosus, Aleyrodes brassicae, Amarasca biguttula, Amritodus atkinsoni, Aonidiella spp., Aonidiella auranti, Aphididae, Aphis spp., Aspidiotus spp., Aulacorthum solani, Bactericera cockereffi, Bemisia spp, Brachycaudus spp, Brevicoryne brassicae, Cacopsylla spp, Cavariella aegopodii Scop., Ceroplaster spp., Chrysomphalus aonidium, Chrysomphalus dictyospermi, Cicadella spp, Cofana spectra, Cryptomyzus spp, Cicadulina spp, Coccus hesperidum, Dalbulus maidis, Dialeurodes spp, Diaphorina citri, Diuraphis noxia, Dysaphis spp, Empoasca spp., Eriosoma larigerum, Erythroneura spp., Gascardia spp., Glycaspis brimblecombei, Hyadaphis pseudobrassicae, Hyalopterus spp, Hyperomyzus pallidus, Idioscopus clypealis, Jacobiasca lybica, Laodelphax spp., Lecanium corni, Lepidosaphes spp., Lopaphis erysimi, Lyogenys maidis, Macrosiphum spp., Mahanarva spp, Metcalfa pruinosa, Metopolophium dirhodum, Myndus crudus, Myzus spp., Neotoxoptera sp, Nephotettix spp., Nilaparvata spp., Nippolachnus piri Mats, Odonaspis ruthae, Oregma lanigera Zehnter, Parabemisia myricae, Paratrioza cockerelli, Parlatoria spp., Pemphigus spp., Peregrinus maidis, Perkinsiella spp, Phorodon humuli, Phylloxera spp, Planococcus spp., Pseudaulacaspis spp., Pseudococcus spp., Pseudatomoscelis seriatus, Psylla spp., Pulvinaria aethiopica, Quadraspidiotus spp., Quesada gigas, Recilia dorsalis, Rhopalosiphum spp., Saissetia spp., Scaphoideus spp., Schizaphis spp., Sitobion spp., Sogatella furcifera, Spissistilus festinus, Tarophagus Proserpina, Toxoptera spp, Trialeurodes spp, Tridiscus sporoboli, Trionymus spp, Trioza erytreae, Unaspis citri, Zygina flammigera, and Zyginidia scutellaris;
from the order Hymenoptera, for example, Acromyrmex, Arge spp, Atta spp., Cephus spp., Diprion spp., Diprionidae, Gilpinia polytoma, Hoplocampa spp., Lasius spp., Monomorium pharaonis, Neodiprion spp., Pogonomyrmex spp, Slenopsis invicta, Solenopsis spp. and Vespa spp.;
from the order Isoptera, for example, Coptotermes spp, Corniternes cumulans, Incisitermes spp, Macrotermes spp, Mastotermes spp, Microtermes spp, Reticulitermes spp.; Solenopsis geminate;
from the order Lepidoptera, for example, Acleris spp., Adoxophyes spp., Aegeria spp., Agrotis spp., Alabama argillaceae, Amylois spp., Anticarsia gemmatalis, Archips spp., Argyresthia spp, Argyrotaenia spp., Autographa spp., Bucculatrix thurberiella, Busseola fusca, Cadra cautella, Carposina nipponensis, Chilo spp., Choristoneura spp., Chrysoteuchia topiaria, Clysia ambiguella, Cnaphalocrocis spp., Cnephasia spp., Cochylis spp., Coleophora spp., Colias lesbia, Cosmophila flava, Crambus spp, Crocidolomia binotalis, Cryptophlebia leucotreta, Cydalima perspectalis, Cydia spp., Diaphania perspectalis, Diatraea spp., Diparopsis castanea, Earias spp., Eldana saccharina, Ephestia spp., Epinotia spp, Estigmene acrea, Etiella zinckinella, Eucosma spp., Eupoecilia ambiguella, Euproctis spp., Euxoa spp., Feltia jaculiferia, Grapholita spp., Hedya nubiferana, Heliothis spp., Hellula undalis, Herpetogramma spp, Hyphantria cunea, Keiferia lycopersicella, Lasmopalpus lignosellus, Leucoptera scitella, Lithocollethis spp., Lobesia botrana, Loxostege bifidalis, Lymantria spp., Lyonetia spp., Malacosoma spp., Mamestra brassicae, Manduca sexta, Mythimna spp, Noctua spp, Operophtera spp., Orniodes indica, Ostrinia nubilalis, Pammene spp., Pandemis spp., Panolis flammea, Papaipema nebris, Pectinophora gossypiela, Perileucoptera coffeella, Pseudaletia unipuncta, Phthorimaea operculella, Pieris rapae, Pieris spp., Plutella xylostella, Prays spp., Pseudoplusia spp, Rachiplusia nu, Richia albicosta, Scirpophaga spp., Sesamia spp., Sparganothis spp., Spodoptera spp., Sylepta derogate, Synanthedon spp., Thaumetopoea spp., Tortrix spp., Trichoplusia ni, Tuta absoluta, and Yponomeuta spp.;
from the order Mallophaga, for example, Damalinea spp. and Trichodectes spp.;
from the order Orthoptera, for example, Blatta spp., Blattella spp., Gryllotalpa spp., Leucophaea maderae, Locusta spp., Neocurtilla hexadactyla, Periplaneta spp., Scapteriscus spp, and Schistocerca spp.;
from the order Psocoptera, for example, Liposcelis spp.;
from the order Siphonaptera, for example, Ceratophyllus spp., Ctenocephalides spp. and Xenopsylla cheopis;
from the order Thysanoptera, for example, Calliothrips phaseoli, Frankliniella spp., Heliothrips spp, Hercinothrips spp., Parthenothrips spp, Scirtothrips aurantii, Sericothrips variabilis, Taeniothrips spp., Thrips spp; and/or
from the order Thysanura, for example, Lepisma saccharina.

Examples of soil-inhabiting pests, which can damage a crop in the early stages of plant development, are:
from the order Lepidoptera, for example, Acleris spp., Aegeria spp., Agrotis spp., Alabama argillaceae, Amylois spp., Autographa spp., Busseola fusca, Cadra cautella, Chilo spp., Crocidolomia binotalis, Diatraea spp., Diparopsis castanea, Elasmopalpus spp., Heliothis spp., Mamestra brassicae, Phthorimaea operculella, Plutella xylostella, Scirpophaga spp., Sesamia spp., Spodoptera spp. and Tortrix spp.;
from the order Coleoptera, for example, Agriotes spp., Anthonomus spp., Atomaria linearis, Chaetocnema tibialis, Conotrachelus spp., Cosmopolites spp., Curculio spp., Dermestes spp., Diabrotica spp., Dilopoderus spp., Epilachna spp., Eremnus spp., Heteronychus spp., Lissorhoptrus spp., Melolontha spp., Orycaephilus spp., Otiorhynchus spp., Phlyctinus spp., Popiffia spp., Psyffiodes spp., Rhizopertha spp., Scarabeidae, Sitotroga spp., Somaticus spp., Tanymecus spp., Tenebrio spp., Tribolium spp., Trogoderma spp. and Zabrus spp.;
from the order Orthoptera, for example, Gryllotalpa spp.;
from the order Isoptera, for example, Reticulitermes spp.;
from the order Psocoptera, for example, Liposcelis spp.;
from the order Anoplura, for example, Haematopinus spp., Linognathus spp., Pediculus spp., Pemphigus spp. and Phylloxera spp.;
from the order Homoptera, for example, Eriosoma larigerum;
from the order Hymenoptera, for example, Acromyrmex, Atta spp., Cephus spp., Lasius spp., Monomorium pharaonis, Neodiprion spp., Solenopsis spp. and Vespa spp.;
from the order Diptera, for example, Tipula spp.;
crucifer flea beetles (Phyllotreta spp.), root maggots (Delia spp.), cabbage seedpod weevil (Ceutorhynchus spp.) and aphids.

In particular, the compositions of the invention may be applied against insects from the order Homoptera (in particular, white flies, aphids, psyllids and armoured and soft scales), Thysanoptera (thrips), Acarina (mites) and Lepidoptera (butterflies and moths, and larva thereof). Preferably, the compositions of the invention may be applied against white flies, aphids, thrips.

Crops of useful plants in which the compositions according to the invention can be used include perennial and annual crops, such as berry plants for example blackberries, blueberries, cranberries, raspberries and strawberries; cereals for example barley, maize (corn), millet, oats, rice, rye, sorghum triticale and wheat; fibre plants for example cotton, flax, hemp, jute and sisal; field crops for example sugar and fodder beet, coffee, hops, mustard, oilseed rape (canola), poppy, sugar cane, sunflower, tea and tobacco; fruit trees for example apple, apricot, avocado, banana, cherry, citrus, nectarine, peach, pear and plum; grasses for example Bermuda grass, bluegrass, bentgrass, centipede grass, fescue, ryegrass, St. Augustine grass and Zoysia grass; herbs such as basil, borage, chives, coriander, lavender, lovage, mint, oregano, parsley, rosemary, sage and thyme; legumes for example beans, lentils, peas and soya beans; nuts for example almond, cashew, ground nut, hazelnut, peanut, pecan, pistachio and walnut; palms for example oil palm; ornamentals for example flowers, shrubs and trees; other trees, for example cacao, coconut, olive and rubber; vegetables for example asparagus, aubergine, broccoli, cabbage, carrot, cucumber, garlic, lettuce, marrow, melon, watermelon, okra, onion, leek, pepper, potato, pumpkin, squash, rhubarb, spinach and tomato; and vines for example grapes. The compositions of the invention can also be applied on turf, lawn and pastures.

Preferably, the compositions of the invention may be applied to a crop of a useful plant selected from:
the order Solanacea (including tomato, potato, aubergine, chilli, pepper, tobacco);
the order Cucurbitaceae (including squash, pumpkin, watermelon, melon, cucumber);
the order Alliaceae (including onion, garlic, leek);
the order Asparagacea (including asparagus).

Preferably, the composition of the invention may be applied to a crop of a useful plant selected from cucumber, squash, pepper, melon, watermelon, tomato, aubergine, courgette or gourd.

The rate at which the agrochemical compositions of the invention are applied will depend upon the particular type of insect, etc, to be controlled, the degree of control required and the timing and method of application and can be readily determined by the person skilled in the art. In general, the compositions of the invention can be applied at an application rate of between 0.005 kilograms/hectare (kg/ha) and about 5.0 kg/ha, based on the total amount of active ingredient in the composition. An application rate of between about 0.1 kg/ha and about 1.5 kg/ha is preferred, with an application rate of between about 0.1 g/ha and 0.5 kg/ha being especially preferred.

The pesticidal compositions of the present invention may be used as an insecticide to control pests on cotton plants or soybean plants, in particular for the control of insects from the order Homoptera (in particular, white flies, aphids, psyllids and armoured and soft scales), Thysanoptera (thrips) and Acarina (mites).

In particular, transgenic cotton events expressing useful traits which may be used in combination with the compositions of the invention, include BXN10211, BXN10215, BXN10222, BXN10224, COT102, COT67B, GHB614, GHB119, LLCotton25, MON531, MON757, MON15985, MON1445, MON88913, MON1076, MON1698, MON88701, T304-40, 281-24-236, 3006-210-23, 31707, 31803, 31808, 42317, and the like. Such combinations of the compositions of the invention with cotton events expressing one or more useful traits may provide more durable yield protection, provide a resistance management strategy for target pest control, and reduce farmer inputs, saving considerable expense in time and monetary value.

Furthermore, transgenic soybean plants expressing toxins, for example insecticidal proteins such as delta-endotoxins, e.g. Cry1Ac (Cry1Ac Bt protein) may be used in combination with the compositions of the invention. Accordingly, this may include transgenic soybean plants comprising event MON87701 (see U.S. Pat. No. 8,049,071 and related applications and patents, as well as WO 2014/170327 A1 (eg, see paragraph reference to Intacta RR2 PRO™ soybean)), event MON87751 (US. Patent Application Publication No. 2014/0373191) or event DAS-81419 (U.S. Pat. No. 8,632,978 and related applications and patents).

Other transgenic soybean plants may comprise event SYHT0H2-HPPD tolerance (U.S. Patent Application Publication No. 2014/0201860 and related applications and patents), event MON89788—glyphosate tolerance (U.S. Pat. No. 7,632,985 and related applications and patents), event MON87708—dicamba tolerance (U.S. Patent Application Publication No. US 2011/0067134 and related applications and patents), event DP-356043-5—glyphosate and ALS tolerance (U.S. Patent Application Publication No. US 2010/0184079 and related applications and patents), event A2704-12—glufosinate tolerance (U.S. Patent Application Publication No. US 2008/0320616 and related applications and patents), event DP-305423-1—ALS tolerance (U.S. Patent Application Publication No. US 2008/0312082 and related applications and patents), event A5547-127—glufosinate tolerance (U.S. Patent Application Publication No. US 2008/0196127 and related applications and patents), event DAS-40278-9—tolerance to 2,4-dichlorophenoxyacetic acid and aryloxyphenoxypropionate (see WO 2011/022469, WO 2011/022470, WO 2011/022471, and related applications and patents), event 127—ALS tolerance (WO 2010/080829 and related applications and patents), event GTS 40-3-2—glyphosate tolerance, event DAS-68416-4-2,4-dichlorophenoxyacetic acid and glufosinate tolerance, event FG72—glyphosate and isoxaflutole tolerance, event BPS-CV127-9—ALS tolerance and GU262—glufosinate tolerance or event SYHT04R—HPPD tolerance.

In an aqueous composition comprising the pesticidal composition according to the invention (eg, a tank-mix composition for spraying) there may be added a further pesticidal active ingredient component (eg, at a weight ratio of 1:1 to spiropidion) selected from one of:

Abamectin, Acequinocyl, Acetoprole, Acrinathrin, Acynonapyr, Afidopyropen, Afoxalaner, Alanycarb, Allethrin, Alpha-Cypermethrin, Alphamethrin, Amidoflumet, Aminocarb, Azocyclotin, Bensultap, Benzoximate, Benzpyrimoxan, Betacyfluthrin, Beta-cypermethrin, Bifenazate, Bifenthrin, Binapacryl, Bioallethrin, Bioallethrin 5)-cyclopentylisomer, Bioresmethrin, Bistrifluron, Broflanilide, Brofluthrinate, Bromophos-ethyl, Buprofezine, Butocarboxim, Cadusafos, Carbaryl, Carbosulfan, Cartap, CAS number: 1472050-04-6, CAS number: 1632218-00-8, CAS number: 1808115-49-2, CAS number: 2032403-97-5, CAS number: 2044701-44-0, CAS number: 2128706-05-6, CAS number: 2249718-27-0, Chlorantraniliprole, Chlordane, Chlorfenapyr, Chloroprallethrin, Chromafenozide, Clenpirin, Cloethocarb, Clothianidin, 2-chlorophenyl N-methylcarbamate (CPMC), Cyanofenphos, Cyantraniliprole, Cyclaniliprole, Cyclobutrifluram, Cycloprothrin, Cycloxaprid, Cycloxaprid, Cyenopyrafen, Cyetpyrafen (or Etpyrafen), Cyflumetofen, Cyfluthrin, Cyhalodiamide, Cyhalothrin, Cypermethrin, Cyphenothrin, Cyproflanilide, Cyromazine, Deltamethrin, Diafenthiuron, Dialifos, Dibrom, Dicloromezotiaz, Diflovidazine, Diflubenzuron, dimpropyridaz, Dinactin, Dinocap, Dinotefuran, Dioxabenzofos, Emamectin, Empenthrin, Epsilon-momfluorothrin, Epsilon-metofluthrin, Esfenvalerate, Ethion, Ethiprole, Etofenprox, Etoxazole, Famphur, Fenazaquin, Fenfluthrin, Fenitrothion, Fenobucarb, Fenothiocarb, Fenoxycarb, Fenpropathrin, Fenpyroxymate, Fensulfothion, Fenthion, Fentinacetate, Fenvalerate, Fipronil, Flometoquin, Flonicamid, Fluacrypyrim, Fluazaindolizine, Fluazuron, Flubendiamide, Flubenzimine, Flucitrinate, Flucycloxuron, Flucythrinate, Fluensulfone, Flufenerim, Flufenprox, Flufiprole, Fluhexafon, Flumethrin, Fluopyram, Flupyradifurone, Flupyrimin, Fluralaner, Flupentiofenox, Fluvalinate, Fluxametamide, Fosthiazate, Gamma-Cyhalothrin, Gossyplure™, Guadipyr, Halofenozide, Halofenozide, Halofenprox, Heptafluthrin, Hexythiazox, Hydramethylnon, Imicyafos, Imidacloprid, Imiprothrin, Indoxacarb, Iodomethane, Iprodione, Isocycloseram, Isothioate, Ivermectin, Kappa-bifenthrin, Kappa-tefluthrin, Lambda-Cyhalothrin, Lepimectin, Lufenuron, Metaflumizone, Metaldehyde, Metam, Methomyl, Methoxyfenozide, Metofluthrin, Metolcarb, Mexacarbate, Milbemectin, Momfluorothrin, nicofluprole Niclosamide, Nitenpyram, Nithiazine, Omethoate, Oxamyl, Oxazosulfyl, Parathion-ethyl, Permethrin, Phenothrin, Phosphocarb, Piperonylbutoxide, Pirimicarb, Pirimiphos-ethyl, Polyhedrosis virus, Prallethrin, Profenofos, Profenofos, Profluthrin, Propargite, Propetamphos, Propoxur, Prothiophos, Protrifenbute, Pyflubumide, Pymetrozine, Pyraclofos, Pyrafluprole, Pyridaben, Pyridalyl, Pyrifluquinazon, Pyrimidifen, Pyrimostrobin, Pyriprole, Pyriproxyfen, Resmethrin, Sarolaner, Selamectin, Silafluofen, Spinetoram, Spinosad, Spirodiclofen, Spiromesifen, Spirotetramat, Sulfoxaflor, Tebufenozide, Tebufenpyrad, Tebupirimiphos, Tefluthrin, Temephos, Tetrachloraniliprole, Tetradiphon, Tetramethrin, Tetramethylfluthrin, Tetranactin, Tetraniliprole, Theta-cypermethrin, Thiacloprid, Thiamethoxam, Thiocyclam, Thiodicarb, Thiofanox, Thiometon, Thiosultap, Tioxazafen, Tolfenpyrad, Toxaphene, Tralomethrin, Transfluthrin, Triazamate, Triazophos, Trichlorfon, Trichloronate, Trichlorphon, Triflumezopyrim, Tyclopyrazoflor, Zeta-Cypermethrin.

The pesticidal compositions of the present invention may be prepared according to standard procedures known in the art.

As already indicated, the pesticidal compositions of the present invention have, for practical purposes, a very advantageous level of activity in controlling insect pests in crops of useful plants after foliar or soil application, whilst also maintaining acceptable crop safety (phytotoxicity) outcomes. Further, the compositions of the present invention when in an agrochemical formulation may possess any number of other benefits compared to other compositions including, inter alia, the prevention of sedimentation, thickening, phase separation, cloudiness, foaming or crystal growth, chemical stability of the spiropidion active ingredient (degradation), long-term formulation stability (eg, at high temperature, such as 45° C.), or reduced clogging of spray nozzles during application and spray drift.

### EXAMPLES

The Examples which follow serve to illustrate the invention, and in particular, demonstrate chemical (active ingredient) and formulation stability for the pesticidal compositions. Table 1 (below) represents a composition A (as a suspension concentrate) according to the invention.

TABLE 1

| | Composition A |
|---|---|
| Component | (% by weight) |
| Spiropidion | 27.7 |
| Atlox ™ 4913 (acrylic graft copolymer | 7.4 |
| solution in water and propylene glycol) | |
| MORWET ™ D-425 (sodium alkyl naphthalene | 1.8 |
| sulfonate formaldehyde condensate) | |
| Anti-freeze agent | 4.6 |
| Thickening agent | 0.5 |
| Preservative agent(s) | 0.3 to 0.4 |
| Buffering agent | 0.2 |
| Anti-foam agent | 0.2 |
| Water | up to 100% |

After storage for 12 weeks at 40° C., no change in the physical properties was observed for Composition A as a stable suspension concentrate formulation according to the invention.

Further, only minimal chemical degradation of the active ingredient spiropidion was observed over a 1-year storage period at 35, 45 and 54° C. as outlined in Table 2 (intervals at 1, 3, 7.5 and 12 months). The percentage amount of spiropidion remaining at each time interval during the high temperature storage testing was compared to an identical sample stored at −18° C. (100%=amount of spiropidion in the −18° C. sample at respective time interval).

TABLE 2

| Storage | % Spiropidion remaining | | | |
|---|---|---|---|---|
| temperature (° C.) | 1 month | 3 months | 7.5 months | 12 months |
| 35 | — | 100 | 99 | 98 |
| 45 | — | 98 | 97 | — |
| 54 | 99 | — | — | — |

These data clearly demonstrate the formulation stability and spiropidion active ingredient stability of the compositions of the invention during a high temperature storage test.

1. A pesticidal composition comprising:
(a) 20 to 35% by weight of spiropidion as active ingredient, and
(b) 5.5 to 15% by weight of a dispersing agent combination, comprising:
(i) 5 to 10% by weight of the total composition of an acrylic graft copolymer solution in water and propylene glycol; and
(ii) 0.5 to 5% by weight of the total composition of a sodium alkyl naphthalene sulfonate formaldehyde condensate.

2. The pesticidal composition according to claim 1, which is a suspension concentrate.

3. The pesticidal composition according to claim 1, wherein spiropidion is present at 25 to 30% by weight.

4. The pesticidal composition according to claim 1, wherein component (i) comprises a methyl methacrylate/methacrylic acid/monomethoxypolyethylene glycol (PEG) methacrylate graft copolymer having a number average molecular weight of 2,500 to 3,000 Da.

5. The pesticidal composition according to claim 1, wherein component (i) is present at 6 to 9% by weight of the total composition.

6. The pesticidal composition according to claim 1, wherein component (ii) is present at 1 to 3% by weight of the total composition.

7. The composition according to claim 1, further comprising one or more additional ingredients selected from an anti-freeze agent, an anti-foam agent, a thickening agent, a biocide (preservative), a buffering agent, a stabilizer and/or a pigment.

8. An aqueous composition comprising the pesticidal composition according to claim 1, optionally further comprising one or more adjuvants or carriers.

9. A method of combating and controlling pests which comprises applying to a pest, to a locus of a pest, or to a crop of a useful plant susceptible to attack by a pest, a composition according to claim 8.

10. The method according to claim 9, wherein the pest is selected from the order Homoptera, Thysanoptera, Acarina or Lepidoptera.

11. The method according to claim 10, wherein the pest is selected from white flies, aphids, thrips.

12. The method according to claim 1, wherein the plant is a perennial plant selected from coffee, citrus, or grape vine.

13. The method according to claim 1, wherein
the plant is soybean or cotton, or
the plant is selected from the order Cucurbitaceae or the order Solanaceae.

14. Use of the composition according to claim 8 for controlling a pest by applying the composition to the growth substrate of a crop of a useful plant.

15. The use according to claim 14, wherein the growth substrate is soil and the application is by drip, drenching or injection of the composition to the soil.
